(19) United States
(12) Patent Application Publication
(10) Pub. No.: US 2017/0164382 A1
(43) Pub. Date: Jun. 8, 2017

(54) DEVICE AND METHOD FOR PERFORMING DEVICE-TO-DEVICE BROADCAST COMMUNICATION IN A WIRELESS NETWORK

(71) Applicant: Alcatel Lucent, Boulogne Billancourt (FR)

(72) Inventors: Yong Liu, Shanghai (CN); Dong Li, Shanghai (CN); Yanli Xu, Shanghai (CN)

(73) Assignee: Alcatel Lucent, Boulogne Billancourt (FR)

(21) Appl. No.: 15/127,569

(22) PCT Filed: Mar. 16, 2015
(86) PCT No.: PCT/IB2015/000514

§ 371 Date: Sep. 20, 2016

(30) Foreign Application Priority Data
Mar. 21, 2014 (CN) 201410109905.2

(51) Int. Cl. H04W 72/12

(52) U.S. Cl. CPC H04W 72/121; H04W 72/12; H04W 72/1263

(57) ABSTRACT

The present invention provides a device and method for performing device-to-device broadcast communication in a wireless communication network, wherein the method comprises the steps of: obtaining a row except a 1st row for device-to-device broadcast in a Walsh matrix; performing device-to-device broadcast based on a transmission pattern determined by the obtained row, wherein the transmission pattern is: performing the following operations based on each element in the row sequentially: when the element is a first value, performing broadcast transmission of a same data packet; when the element is a second value, performing broadcast reception. Compared with the prior art, the present invention overcomes semi-duplexing limitation and reduces in-band emission, thereby achieves a better system performance.

### FIELD OF THE INVENTION

The present invention relates to the field of wireless communication, and more specifically to a device and method for performing device-to-device broadcast communication in a wireless communication network.

### BACKGROUND OF THE INVENTION

Device-to-device communication is a research task in LTE R12 for studying performance and standardization of device-to-device communication in an LTE network. This research task will study neighbor discovery and direct communication technology. For the direct communication technology, the device-to-device broadcast communication is studied in priority. Device-to-device application scenarios include full network coverage, no network coverage, and partial network coverage. The device-to-device broadcast communication under no network coverage is currently a focus of study. Moreover, in device-to-device broadcast communication, VoIP (Voice over IP) communication is the most important task. It requires that a broadcast packet should reach a user equipment as far as possible. In order to increase coverage, for transmission of a broadcast VoIP packet, a narrowband (as low as 2 or 3 resource blocks) is a suitable selection. For a larger channel bandwidth (e.g., 50 resource blocks), we need to perform frequency domain multiplexing broadcast transmission to multiple user equipments so as to sufficiently use the available frequency spectrum resources. However, this causes semi-duplexing limitation and in-band emission, and finally dampens broadcast performance.

Therefore, in device-to-device broadcast communication, it becomes an imminent problem to be solved how to overcome semi-duplexing limitation and reduce in-band emission.

### SUMMARY OF THE INVENTION

An objective of the present invention is to provide a device and a method for performing device-to-device broadcast communication in a wireless communication network.

According to one aspect of the present invention, there is disclosed a method for performing device-to-device broadcast communication in a user equipment of a wireless communication network, the method comprising steps of:
obtaining a row except a 1^{st} row for device-to-device broadcast in a Walsh matrix;
performing device-to-device broadcast based on a transmission pattern determined by the obtained row, wherein the transmission pattern is: performing the following operations based on each element in the row sequentially:
   when the element is a first value, performing broadcast transmission of a same data packet;
   when the element is a second value, performing broadcast reception.

According to another aspect of the present invention, there is provided a user equipment for performing device-to-device broadcast communication in a wireless communication network, the equipment comprising:
a row first obtaining module configured to obtain a row except a 1^{st} row for device-to-device broadcast in a Walsh matrix;
a broadcasting module configured to perform device-to-device broadcast based on a transmission pattern determined by the obtained row, wherein the transmission pattern is: performing the following operations based on each element in the row sequentially:
   when the element is a first value, performing broadcast transmission of a same data packet;
   when the element is a second value, performing broadcast reception.

According to a further aspect of the present invention, there is provided a method for facilitating device-to-device broadcast communication at a base station of a wireless communication network, the method comprises steps of:
determining, for a user equipment, a row except a 1^{st} row for the user equipment's device-to-device broadcast in a Walsh matrix;
transmitting, to the user equipment, indication information for indicating a row except the 1^{st} row for the user equipment's device-to-device broadcast in the Walsh matrix.

According to a still further aspect of the present invention, there is provided a base station facilitating device-to-device broadcast communication at a base station of a wireless communication network, the base station comprising:
a row determining module configured to determine, for a user equipment, a row except a 1^{st} row for the user equipment's device-to-device broadcast in a Walsh matrix;
an indication information transmitting module configured to transmit, to the user equipment, indication information for indicating a row except the 1^{st} row for the user equipment's device-to-device broadcast in the Walsh matrix.

Compared with the prior art, the present invention has the following advantages: through the solution of the present invention, a user equipment performing broadcast determines a transmission pattern based on a Walsh matrix before performing data transmission, such that when the user does not perform transmission, it may have an opportunity to receive broadcast data from other user equipment using a different transmission pattern, thereby overcoming semi-duplexing limitation. Moreover, because different user equipments may use different transmission patterns to perform transmission, the odds for different user equipments to perform transmission simultaneously are lowered, thereby reducing in-band emission and achieving a better system performance.

### BRIEF DESCRIPTION OF THE ACCOMPANYING DRAWINGS

Other features, objectives and advantages of the present invention will become more apparent through reading the following detailed description of the non-limiting embodiments with reference to the accompanying drawings below:

FIG. 1 shows a schematic diagram of device-to-device broadcast communication in a wireless communication network;

FIG. 2 shows a flow diagram of a method for performing device-to-device broadcast communication in a user equipment of a wireless communication network according to one embodiment of one aspect of the present invention;

FIG. 3 shows an instance of a Walsh matrix;

FIG. 4 shows an instance of a transmission pattern for performing device-to-device broadcast communication in a user equipment of a wireless communication network according to an embodiment of the present invention;

FIG. 5 shows a flow diagram of obtaining a row except the 1^{st} row for de vice-to-device broadcast in a Walsh matrix according to another embodiment of the present invention;

FIG. 6a shows a schematic diagram of a Walsh matrix and a transmission pattern according to a further embodiment of the present invention;

FIG. 6b shows a schematic diagram of a transmission pattern according to a still further embodiment of the present invention;

FIG. 7 shows a schematic diagram of a user equipment for performing device-to-device broadcast communication in a wireless communication network according to another aspect of the present invention;

FIG. 8 shows a flow diagram of a method for facilitating device-to-device broadcast communication in a base station of a wireless communication network according to one embodiment of a further aspect of the present invention;

FIG. 9 shows a base station for facilitating device-to-device broadcast communication in a wireless communication network according to a still further aspect of the present invention;

Same or similar reference numerals in the accompanying drawings represent same or similar components.

### DETAILED DESCRIPTION OF THE PREFERRED EMBODIMENTS

Hereinafter, the present invention will be described in further detail with reference to the accompanying drawings.

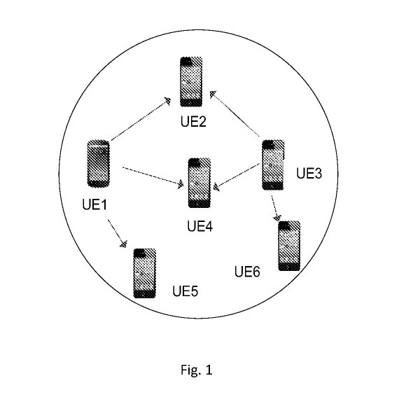

FIG. 1 shows a schematic diagram of performing device-to-device communication in a wireless communication network. Generally, a wireless communication network may include a plurality of user equipments (hereinafter shortly referred to as UE). In FIG. 1, an instance of device-to-device broadcast communication is schematically illustrated with 6 user equipments UE1, UE2, . . . , UE6 therein. In one embodiment, the wireless communication network is one based on a 3GPP (the 3^{rd} Generation Partnership Project) protocol. Preferably, the wireless communication network may be a LTE (Long Term Evolution) network. The user equipment may be any kind of electronic device that can communicate directly or indirectly with other user equipment and/or base station in a wireless manner, including, but not limited to, a mobile phone, a PDA, etc. Preferably, respective user equipments in the LTE network adopts a frequency-division duplexing pattern (FDD pattern) or adopts a time-division duplexing pattern (TDD pattern) to transmit and receive information. The wireless communication network may also include a plurality of base stations (not shown). The base station may be, e.g., eNodeB, which may communicate with other base stations and/or user equipments. Those skilled in the art should understand that the wireless communication network, user equipment and/or base station described here are illustrative, not limitative, and the principle of the present method is applicable to any other existing or future possibly emerging wireless communication networks, user equipments and/or base stations without departing from the spirit and scope of the present invention, and are incorporated here by reference.

As shown in FIG. 1, UE1 and UE3 are transmitting a device-to-device broadcast signal to other user equipments. Here, UE2 and UE4 are in a common coverage of UE1 and UE3, such that UE2 and UE4 will receive broadcast signals from UE1 and UE3, and signal interference might exist between the broadcast signals received by UE2 and UE4. Besides, the received signal interference at respective user equipments not only comes from interference between signals transmitted simultaneously on a same resource from respective user equipments, but also comes from in-band emission of signals transmitted on a same transmission time domain and transmitted using an orthogonal frequency resource from respective user equipments. Therefore, in order to reduce signal interference and in-band emission, it is needed to coordinate respective user equipments transmitting broadcast signals, such that respective user equipments transmit broadcast signals on different frequency domain and time domain resources as far as possible.

Besides, as shown in the figure, UE1 and UE3 are transmitting device-to-device broadcast signals to other user equipments. It would be easily appreciated that because they are now transmitting, UE1 and UE3 cannot receive the broadcast signals transmitted by each other. Therefore, in order to overcome the limitation due to the semi-duplexing communication manner, it is needed to coordinate respective user equipments that perform broadcast communication, such that respective user equipments can transmit broadcast signals to each other, and respective user equipments can receive the broadcast signals transmitted from each other.

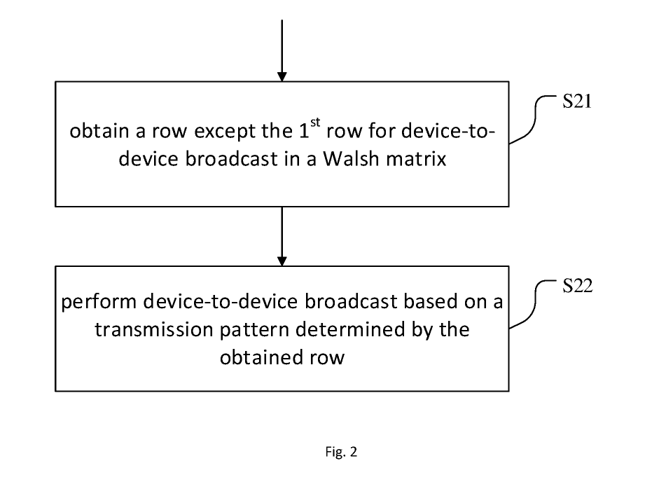

FIG. 2 shows a flow diagram of a method for performing device-to-device broadcast communication in a user equipment of a wireless communication network according to one embodiment of one aspect of the present invention.

First , in step S21, a row except the 1^{st} row for device-to-device broadcast in a Walsh matrix is obtained. Here, the user equipment may pre-save a Walsh matrix, or get a Walsh matrix through a base station serving the user equipment.

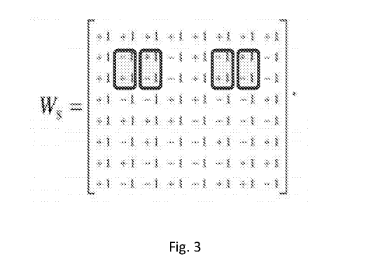

FIG. 3 shows an instance of a Walsh matrix. As is well known, the Walsh matrix has the following characteristics, wherein N is an order of the Walsh matrix:

1. For each row of Walsh matrix (except the 1^{st}row which is the all +1 row), N/2 elements is +1, while the remaining N/2 element is −1.

2. For any two rows (except the 1^{st} row) of the Walsh matrix, e.g., 2^{nd} and 3^{rd} rows in FIG. 2, there are N/4 pairs of {+1, −1}, and N/4 pairs {−b 1, +1}.

3. Except the 1^{st} row and the (N/2+1)th row, the +1 elements are spread in a row.

We select any row except the 1^{st} row in the Walsh matrix to determine a transmission pattern of the user equipment, i.e., whether to perform transmission or reception of device-to-device broadcast communication: checking each element in the row sequentially; when the element is a first value, broadcast transmission of the same data packet is performed; when the element is a second value, broadcast reception is performed. Here, the first value may be +1, or −1, for example. The second value should be different from the first value. For example, when the first value is +1, the second value may be −1; vice versa. Those skilled in the art should understand that the values of the first value and the second value described here are exemplary and non-limitative; and there are other implementations without departing from the spirit and scope of the present invention, which are incorporated here by reference. To ease the discussion, we use +1 as the first value and −1 as the second value hereinafter, unless otherwise specificially indicated. According to such a transmission pattern, when any two user equipments (denoted as UE1 and UE2) use different rows in the Walsh matrix (denoted as L1 and L2) to perform broadcast communication, because there are N/4 pairs of {+1, −1} between L1 and L2, then there are N/4 opportunities between UE1 and UE2 to perform broadcast transmission from UE1 to UE2; moreover, because there are N/4 pairs {−1, +1} between L1 and L2, there are N/4 opportunities between UE1 and UE2 to perform broadcast transmission from UE2 to UE1. In this way, two-way broadcast transmission can be performed between UE1 and UE2, thereby overcoming the limitation of semi-duplexing communication. Moreover, because NE1 and NE2 perform broadcast transmission using different transmission patterns, the odds for the user equipments to transmit simultaneously is reduced, and thereby signal interference and in-band emission are reduced.

As mentioned above, by virtue of the above characteristics of the Walsh matrix, for user equipments that need to perform broadcast communications to each other, different rows in the Walsh matrix may be selected to coordinate each other's device-to-device broadcast communication, thereby overcoming the semi-duplexing communication limitation and enhancing system performance.

In addition, at the convenience of description, a row in the Walsh matrix as mentioned refers to a row except the 1^{st} row in the Walsh matrix hereinafter, unless otherwise specifically indicated. Besides, again, for the ease of description, +1 is taken as the first value and −1 is taken as the second value hereinafter, unless otherwise specifically indicated. Those skilled in the art should understand that the values of the first value and the second value described here are exemplary, not limitative, and there are other implementation manners without departing from the spirit and scope of the present invention, which are incorporated here by reference.

Specifically, in step S21, a user equipment may randomly select a row except the 1^{st} row from a Walsh matrix, or the user equipment may obtain a row except the 1^{st} row for device-to-device broadcast in a Walsh matrix through receiving indication information that is received from a base station serving the user equipment which includes an indication of a row except the 1^{st} row for device-to-device broadcast in a Walsh matrix. Moreover, preferably, the base station may select a row except the 1^{st} row which has not been obtained by other user equipment in a Walsh matrix, and transmit corresponding indication information to the user equipment. Besides, in another embodiment, when the base station checks that all rows (except the 1^{st} row) have been used by the user equipments, the base station may, for example, interact with a user equipment to know other user equipments which the user equipment needn't receive broadcast information from or is not interested, and select a row in the Walsh matrix selected by such other user equipments, and transmit corresponding indication information to the user equipment. Those skilled in the art should understand, the method of selecting, by the base station, a row in the Walsh matrix, is exemplary, not limitative. There are various other implementation manners without departing from the spirit and scope of the present invention, which are incorporated here by reference.

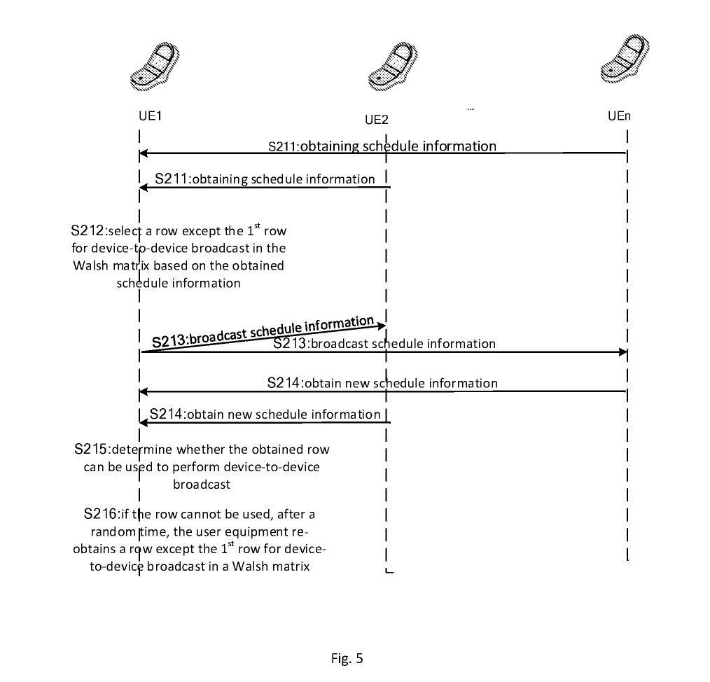

When describing the embodiment of FIG. 5 hereinafter, we will further illustrate a method of obtaining a row for device-to-device broadcast communication in a Walsh matrix according to other embodiments of the present invention.

Next, in step S22, the user equipment performs device-to-device communication based on the transmission pattern determined by the obtained row. The transmission pattern is that the user equipment performs the following operations based on each element in the row: when the element is the first value, performing broadcast transmission of the same data packet; when the element is the second value, performing broadcast reception. Specifically, the user equipment determines a transmission resource for device-to-device broadcast communication, e.g., a resource block and a subframe, and then users the resource block and the subframe to perform device-to-device broadcast communication according to the above transmission pattern.

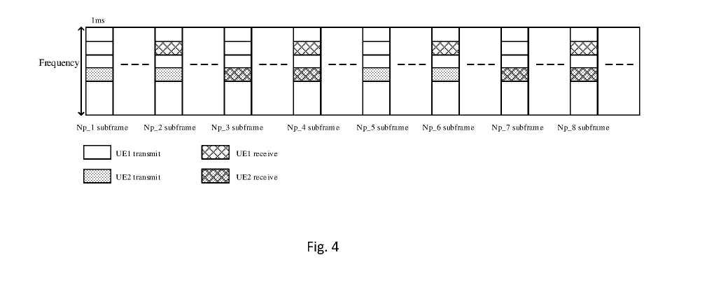

FIG. 4 shows a transmission pattern for performing device-to-device broadcast communication in a user equipment of a wireless communication network according to the embodiments of the present invention. In FIG. 4, user equipments UE1 and UE2 are still used to illustrate the abovementioned transmission pattern according to the embodiments of the present invention, wherein it is assumed that user equipments UE1 and UE2 obtain the 2^{nd} row and 3^{rd} row of the Walsh matrix illustrated in FIG. 3 respectively. It is seen that according to the 2^{nd} row of the Walsh matrix, i.e., {+1, −1, +1, −1, +1, −1, +1, −1}, UE1 consecutively performs transmission of the same data packet and/or reception based on each element of the row sequentially. When the element is +1, transmission is performed; when the element is −1, reception is performed. Therefore, as shown in FIG. 4, the transmission pattern used by UE1 is {transmission, reception, transmission, reception, transmission, reception, transmission, reception}. Similarly, as shown in FIG. 4, the transmission pattern used by the user equipment UE2 is {transmission, transmission, reception, reception, transmission, transmission, reception, reception}. As shown in FIG. 4, in subframe Np_3 and subframe Np_7, the user equipment UE1 performs broadcast transmission, and the user equipment UE2 performs broadcast reception; therefore, the user equipment UE2 may receive broadcast from the user equipment UE1. Similarly, as shown in FIG. 4, in subframe Np_2 and subframe NP_6, the user equipment UE2 performs broadcast transmission, and the user equipment UE1 performs broadcast reception; therefore, the user equipment UE1 may receive broadcast from the user equipment UE2. In this way, the user equipments UE1 and UE2 overcome the limitation of semi-duplexing communication.

Besides, when the user equipment performs multiple transmissions for the same data packet according to the method described above, the user equipment may use the same redundant version upon transmission such that the user equipment receiving such data packet may perform tracking and combination. Or, the user equipment may use a fixed sequence of different redundant versions upon transmission, such that the user equipment receiving that data packet may obtain an incremental redundant gain.

In addition, in one preferred embodiment, when the user equipment performs device-to-device broadcast communication based on the transmission pattern determined by the obtained row, it may also obtain a frequency diversity gain in conjunction with a frequency hopping technique. Because those skilled in the art already know the frequency hopping technique, it will not be detailed here.

As mentioned above, according to the characteristics of the Walsh matrix, when the order of the Walsh matrix is N, the user equipment that selects a row except the 1^{st} row in the Walsh matrix may perform N/2 times of transmission and N/2 times of reception. Therefore, the times of repetitive transmission required for a data packet may be first determined, which is assumed to be X; then it may be derived that an appropriate order of the Walsh matrix is 2*X, such that a Walsh matrix of an order of 2*N may be selected from existing Walsh matrixes. As indicated above, the user equipment may pre-save respective Walsh matrixes, or obtain an appropriate Walsh matrix from the base station serving the user equipment.

FIG. 5 shows a flow diagram of obtaining a row except the 1^{st} row for device-to-device broadcast in a Walsh matrix according to more embodiments of the present invention.

First, in step S211, a user equipment obtains schedule information including a row selected by other user equipment for device-to-device broadcast in the Walsh matrix. Specifically, as shown in FIG. 5, the user equipment may receive the schedule information from other user equipment. Or, in another embodiment, respective user equipments may transmit the information of the row in the Walsh matrix selected by themselves to base stations. Respectively base stations communication with each other and maintain rows in the Walsh matrix selected by the respective user equipments, and then a user equipment may obtain the schedule information including rows for device-to-device broadcast in the Walsh matrix selected by other user equipments from a base station serving the user equipment.

Next, in step S212, the user equipment selects a row except the 1^{st} row for device-to-device broadcast in the Walsh matrix based on the obtained schedule information. Preferably, the user equipment selects a row except the 1^{st} row which has not used by other user equipments yet in the Walsh matrix. In a further embodiment, when all rows except the 1^{st} row in the Walsh matrix are used by other users, the user equipment may first determine other equipments that needn't receive broadcast signals from or is not interest, and then select a row in the rows selected by the other equipments. Since the technology for the user equipment to determine other equipment that needn't receive broadcast signals from or is not interest is known to those skilled in the art, it will not be detailed here.

Because two or more user equipments performing selection at the same time based on their respective obtained schedule information might select a same role in the Walsh matrix, i.e., having conflict, a method for conflict resolution according to the embodiments of the present invention will be further described hereinafter. We use user equipment UE1 and UE2 as an example to make a further illustration.

Specifically, when a user equipment selects a row in the Walsh matrix, in step S213, the user equipment broadcasts schedule information including the selected row. Here, suppose the rows selected by the user equipments UE1 and UE2 are L1 and L2. Next, in step S214, the user equipment obtains new schedule information including rows for device-to-device broadcast in the Walsh matrix selected by other user equipments. In this step, the user equipment UE1 knows that the row selected by the user equipment UE2 is L2 through the obtained new schedule message; likewise, the user equipment UE2 knows the row selected by the user equipment UE1 is L1 through the obtained new schedule message. Next, in step S215, the user equipment determines whether the selected row can be used to perform device-to-device broadcast based on the obtained new schedule information. For example, the user equipments UE1 and UE2 check whether L1 is equal to L2. When L1 is not equal to L2, the UE1 and UE2 determine that they may use their respectively selected rows to perform device-to-device broadcast. However, when L1 is equal to L2, the UE1 and UE2 determine that the selections have a conflict, and the original selections cannot be used to perform device-to-device broadcast. In the latter case, in step S216, after a random time, the user equipment re-obtains a row except the 1^{st} row for device-to-device broadcast in a Walsh matrix. Here, the user equipment may re-obtain a row except the 1^{st} row for device-to-device broadcast in a Walsh matrix in a manner identical or similar to the abovementioned manner.

When a user equipment transmits and receives schedule information including the selected row in a broadcast manner, in one embodiment, the user equipment may randomly select when to transmit and/or receive the schedule information. In a further embodiment, the user equipments may coordinate the transmission and/or reception of the schedule information using the above transmission pattern determined based on a row in the Walsh matrix.

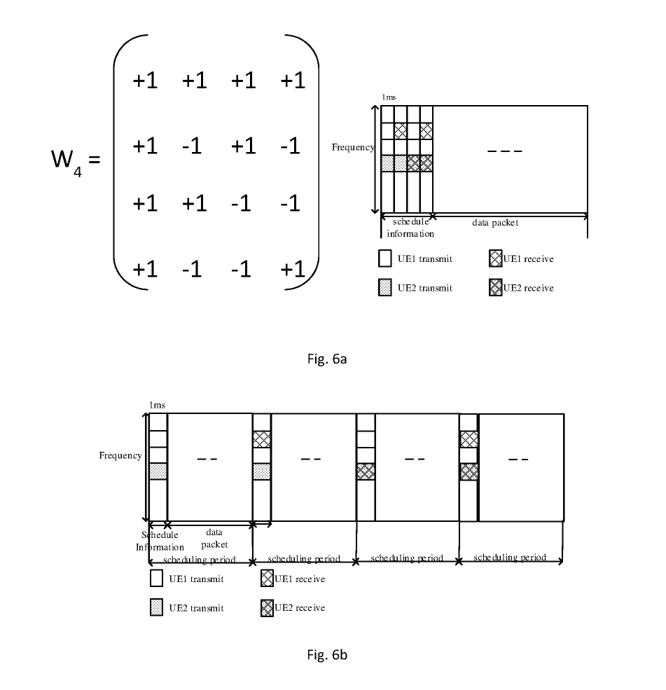

Specifically, the user equipment obtains a row except the 1^{st} row for device-to-device broadcast of schedule information in a Walsh matrix. It should be noted that the Walsh matrix used here may be identical to or different from the Walsh matrix used in the previous embodiments. In other words, for reception/ transmission of schedule information, the user equipment may use a different Walsh matrix. As shown in FIG. 6a, the user equipment may use a Walsh matrix with an order of 4, and obtain a row for schedule information in the Walsh matrix using the method described above. Next, device-to-device schedule information is broadcast based on the transmission pattern determined by the obtained row, wherein, as abovementioned, the transmission pattern is: in the one or more scheduling periods, performing the following operations based on each element in the row: when the element is the first value, performing broadcast transmission of the same schedule information; when the element is the second value, performing broadcast reception of schedule information. As shown in FIG. 6a, the user equipment UE1 and the user equipment UE2 obtain the second row and the third row in the Walsh matrix, respectively, and perform transmission and/or reception based on the transmission patterns of the rows respectively obtained by them. Because obtaining a row in a Walsh matrix and the transmission pattern have been described above in detail, they will not be repeated here.

In another embodiment, as shown in FIG. 6b, the user equipment performs repetitive transmission and/or reception of the device-to-device broadcast in one or more scheduling periods. The scheduling period here may be preset for example a value of 20 ms. Moreover, when performing repetitive transmission and/or reception of device-to-device broadcast in one or more scheduling periods, the user equipment performs device-to-device schedule information broadcast based on the transmission pattern determined by the obtained row for device-to-device broadcast of schedule information according to the method described above in the one or more scheduling periods. Moreover, in another embodiment, when the user equipment performs repetitive transmission and/or reception of the device-to-device broadcast in a plurality of scheduling periods, the user equipment performs device-to-device schedule information broadcast based on the transmission pattern determined for the obtained row for device-to-device broadcast of schedule information in respective scheduling periods according to the method described above; and the sequence number of the corresponding scheduling period is also broadcast simultaneously. In this way, when the user equipment obtains schedule information of other user equipment according to the method described above, it will simultaneously obtain the corresponding scheduling period sequence number, and uses the sequence number for merging the plurality of repetitive broadcasts. Additionally, in one preferred embodiment, when the user equipment performs repetitive transmission and/or reception of the device-to-device broadcast of schedule information in a plurality of scheduling periods, the user equipment may re-obtain a row in a Walsh matrix for device-to-device broadcast of schedule information according to the manner described above in different scheduling periods, thereby further avoiding the limitation of semi-duplexing.

In a preferred embodiment, the schedule information as described above may further include information of the transmission resource used by the user equipment for performing device-to-device broadcast communication, e.g., a resource block, etc. Based on the obtained transmission resource information, the user may select an appropriate transmission resource, e.g., an unused transmission resource, to perform device-to-device broadcast.

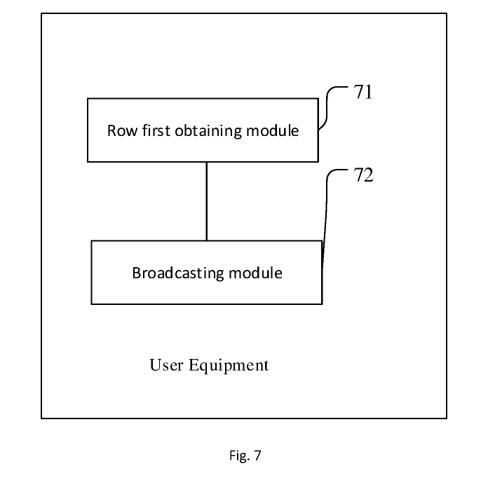

FIG. 7 shows a schematic diagram of a user equipment for performing device-to-device broadcast communication in a wireless communication network according to another aspect of the present invention.

First , a row first obtaining module obtains a row except the 1^{st} row for device-to-device broadcast in a Walsh matrix is obtained. Here, the user equipment may pre-save a Walsh matrix, or get a Walsh matrix through a base station serving the user equipment.

FIG. 3 shows an instance of a Walsh matrix. As is well known, the Walsh matrix has the following characteristics, wherein N is an order of the Walsh matrix:

1. For each row of Walsh matrix (except the 1^{st}row which is the all +1 row), N/2 elements is +1, while the remaining N/2 element is −1.

2. For any two rows (except the 1^{st} row) of the Walsh matrix, e.g., 2^{nd} and 3^{rd} rows in FIG. 2, there are N/4 pairs of {+1, −1}, and N/4 pairs {−1, +1}.

3. Except the 1^{st} row and the (N/2+1)th row, the +1 elements are spread in a row.

We select any row except the 1^{st} row in the Walsh matrix to determine a transmission pattern of the user equipment, i.e., whether to perform transmission or reception of device-to-device broadcast communication: checking each element in the row in sequence; when the element has a first value, broadcast transmission of the same data packet is performed; when the element has a second value, broadcast reception is performed. Here, the first value may be +1, or −1, for example. The second value should be different from the first value. For example, when the first value is +1, the second value may be −1; vice versa. Those skilled in the art should understand that the values of the first value and the second value described here are exemplary and non-limitative; and there are other implementations without departing from the spirit and scope of the present invention, which are incorporated here by reference. To ease the discussion, we use +1 as the first value and −1 as the second value hereinafter, unless otherwise specificially indicated. According to such a transmission pattern, when any two user equipments (denoted as UE1 and UE2) use different rows in the Walsh matrix (denoted as L1 and L2) to perform broadcast communication, because there are N/4 pairs of {+1, −1} between L1 and L2, then there are N/4 opportunities between UE1 and UE2 to perform broadcast transmission from UE1 to UE2; moreover, because there are N/4 pairs {−1, +1} between L1 and L2, there are N/4 opportunities between UE1 and UE2 to perform broadcast transmission from UE2 to UE1. In this way, two-way broadcast transmission can be performed between UE1 and UE2, thereby overcoming the limitation of semi-duplexing communication. Moreover, because NE1 and NE2 perform broadcast transmission using different transmission patterns, the odds for the user equipments to transmit simultaneously is reduced, and thereby signal interference and in-band emission are reduced.

As mentioned above, by virtue of the above characteristics of the Walsh matrix, for user equipments that need to perform broadcast communications to each other, different rows in the Walsh matrix may be selected to coordinate each other's device-to-device broadcast communication, thereby overcoming the semi-duplexing communication limitation and enhancing system performance.

In addition, for the convenience of description, a row in the Walsh matrix as mentioned refers to a row except the 1^{st} row in the Walsh matrix hereinafter, unless otherwise specifically indicated. Besides, again, for the ease of description, +1 is taken as the first value and −1 is taken as the second value hereinafter, unless otherwise specifically indicated. Those skilled in the art should understand that the values of the first value and the second value described here are exemplary, not limitative, and there are other implementation manners without departing from the spirit and scope of the present invention, which are incorporated here by reference.

Specifically, the row first obtaining module may randomly select a row except the 1^{st} row from a Walsh matrix, or an indication information receiving module may receive indication information that is received from a base station serving the user equipment which includes an indication of a row except the 1^{st} row for device-to-device broadcast in a Walsh matrix, and a row third obtaining module may obtain a row except the 1^{st} row for device-to-device broadcast in a Walsh matrix according to the received indication information. Moreover, preferably, the base station may select a row except the 1^{st} row which has not been obtained by other user equipment in a Walsh matrix, and transmit corresponding indication information to the user equipment. Besides, in another embodiment, when the base station checks that all rows (except the 1^{st} row) have been used by the user equipments, the base station may, for example, interact with a user equipment to know other user equipments which the user equipment needn't receive broadcast information from or is not interested, and select a row in the Walsh matrix selected by such other user equipments, and transmit corresponding indication information to the user equipment. Those skilled in the art should understand, the method of selecting, by the base station, a row in the Walsh matrix, is exemplary, not limitative. There are various other implementation manners without departing from the spirit and scope of the present invention, which are incorporated here by reference.

A broadcasting module performs device-to-device communication based on the transmission pattern determined by the obtained row. The transmission pattern is that the user equipment performs the following operations based on each element in the row: when the element is the first value, performing broadcast transmission of the same data packet; when the element is the second value, performing broadcast reception. Specifically, the user equipment determines a transmission resource for device-to-device broadcast communication, e.g., a resource block and a subframe, and then users the resource block and the subframe to perform device-to-device broadcast communication according to the above transmission pattern. FIG. 4 shows a transmission pattern for performing device-to-device broadcast communication in a user equipment of a wireless communication network according to the embodiments of the present invention. In FIG. 4, user equipments UE1 and UE2 are still used to illustrate the abovementioned transmission pattern according to the embodiments of the present invention, wherein it is assumed that user equipments UE1 and UE2 obtain the 2^{nd} row and 3^{rd} row of the Walsh matrix illustrated in FIG. 3 respectively. It is seen that according to the 2^{nd} row of the Walsh matrix, i.e., {+1, −1, +1, −1, +1, −1, +1, −1}, UE1 consecutively performs transmission of the same data packet and/or reception based on each element of the row sequentially. When the element is +1, transmission is performed; when the element is −1, reception is performed. Therefore, as shown in FIG. 4, the transmission pattern used by UE1 is {transmission, reception, transmission, reception, transmission, reception, transmission, reception}. Similarly, as shown in FIG. 4, the transmission pattern used by the user equipment UE2 is {transmission, transmission, reception, reception, transmission, transmission, reception, reception}. As shown in FIG. 4, in subframe Np_3 and subframe Np_7, the user equipment UE1 performs broadcast transmission, and the user equipment UE2 performs broadcast reception; therefore, the user equipment UE2 may receive broadcast from the user equipment UE1. Similarly, as shown in FIG. 4, in subframe Np_2 and subframe NP_6, the user equipment UE2 performs broadcast transmission, and the user equipment UE1 performs broadcast reception; therefore, the user equipment UE1 may receive broadcast from the user equipment UE2. In this way, the user equipments UE1 and UE2 overcome the limitation of semi-duplexing communication.

Besides, when the user equipment performs multiple transmissions for the same data packet according to the method described above, the user equipment may use the same redundant version upon transmission such that the user equipment receiving such data packet may perform tracking and combination. Or, the user equipment may use a fixed sequence of different redundant versions upon transmission, such that the user equipment receiving that data packet may obtain an incremental redundant gain.

In addition, in one preferred embodiment, when the user equipment performs device-to-device broadcast communication based on the transmission pattern determined by the obtained row, it may also obtain a frequency diversity gain in conjunction with a frequency hopping technique. Because those skilled in the art already know the frequency hopping technique, it will not be detailed here.

As mentioned above, according to the characteristics of the Walsh matrix, when the order of the Walsh matrix is N, the user equipment that selects a row except the 1^{st} row in the Walsh matrix may perform N/2 times of transmission and N/2 times of reception. Therefore, the times of repetitive transmission required for a data packet may be first determined, which is assumed to be X; then it may be derived that an appropriate order of the Walsh matrix is 2*X, such that a Walsh matrix of an order of 2*N may be selected from existing Walsh matrixes. As indicated above, the user equipment may pre-save respective Walsh matrixes, or obtain an appropriate Walsh matrix from the base station serving the user equipment.

The following describes the equipment for obtaining a row except the 1^{st} row for device-to-device broadcast in a Walsh matrix according to more embodiments of the present invention.

In one embodiment, a schedule information first broadcasting module obtains schedule information including a row selected by other user equipment for device-to-device broadcast in the Walsh matrix. Specifically, as shown in FIG. 5, the schedule information first broadcasting module may receive the schedule information from other user equipment. Or, in another embodiment, respective user equipments may transmit the information of the row in the Walsh matrix selected by themselves to base stations. Respectively base stations communication with each other and maintain rows in the Walsh matrix selected by the respective user equipments, and then the schedule information first broadcasting module of a user equipment may obtain the schedule information including rows for device-to-device broadcast in the Walsh matrix selected by other user equipments from a base station serving the user equipment.

Next, a row fourth obtaining module selects a row except the 1^{st} row for device-to-device broadcast in the Walsh matrix based on the obtained schedule information. Preferably, the row fourth obtaining module selects a row except the 1^{st} row which has not used by other user equipments yet in the Walsh matrix. In a further embodiment, when all rows except the 1^{st} row in the Walsh matrix are used by other users, the user equipment may first determine other equipments that needn't receive broadcast signals from or is not interest, and then select a row in the rows selected by the other equipments. Since the technology for the user equipment to determine other equipment that needn't receive broadcast signals from or is not interest is known to those skilled in the art, it will not be detailed here.

Because two or more user equipments performing selection at the same time based on their respective obtained schedule information might select a same role in the Walsh matrix, i.e., having conflict, a method for conflict resolution according to the embodiments of the present invention will be further described hereinafter. We use user equipment UE1 and UE2 as an example to make a further illustration.

Specifically, when the row fourth obtaining module selects a row in the Walsh matrix, a schedule information first broadcasting module broadcasts schedule information including the selected row. Here, suppose the rows selected by the user equipments UE1 and UE2 are L1 and L2. Next, a schedule information second obtaining module obtains new schedule information including rows for device-to-device broadcast in the Walsh matrix selected by other user equipments. In this step, the user equipment UE1 knows that the row selected by the user equipment UE2 is L2 through the obtained new schedule message; likewise, the user equipment UE2 knows the row selected by the user equipment UE1 is L1 through the obtained new schedule message. Next, a determining module determines whether the selected row can be used to perform device-to-device broadcast based on the obtained new schedule information. For example, the determining modules of the user equipments UE1 and UE2 check whether L1 is equal to L2. When L1 is not equal to L2, the determining modules of the UE1 and UE2 determine that they may use their respectively selected rows to perform device-to-device broadcast. However, when L1 is equal to L2, the determining modules of the UE1 and UE2 determine that the selections have a conflict, and the original selections cannot be used to perform device-to-device broadcast. In the latter case, a row re-obtaining module, after a random time, the user equipment re-obtains a row except the 1^{st} row for device-to-device broadcast in a Walsh matrix. Here, the row re-obtaining module may re-obtain a row except the 1^{st} row for device-to-device broadcast in a Walsh matrix in a manner identical or similar to the abovementioned manner.

When a user equipment transmits and receives schedule information including the selected row in a broadcast manner, in one embodiment, the user equipment may randomly select when to transmit and/or receive the schedule information. In a further embodiment, the user equipments may coordinate the transmission and/or reception of the schedule information using the above transmission pattern determined based on a row in the Walsh matrix.

Specifically, a row fifth obtaining module obtains a row except the 1^{st} row for device-to-device broadcast of schedule information in a Walsh matrix. It should be noted that the Walsh matrix used here may be identical to or different from the Walsh matrix used in the previous embodiments. In other words, for reception/ transmission of schedule information, the user equipment may use a different Walsh matrix. As shown in FIG. 6a, the user equipment may use a Walsh matrix with an order of 4, and obtain a row for schedule information in the Walsh matrix using the method described above. Next, device-to-device schedule information is broadcast by a schedule information second broadcasting module based on the transmission pattern determined by the obtained row, wherein, as abovementioned, the transmission pattern is: in the one or more scheduling periods, performing the following operations based on each element in the row: when the element is the first value, performing broadcast transmission of the same schedule information; when the element is the second value, performing broadcast reception of schedule information. As shown in FIG. 6a, the user equipment UE1 and the user equipment UE2 obtain the second row and the third row in the Walsh matrix, respectively, and perform transmission and/or reception based on the transmission patterns of the rows respectively obtained by them. Because obtaining a row in a Walsh matrix and the transmission pattern have been described above in detail, they will not be repeated here.

In another embodiment, as shown in FIG. 6b, the user equipment performs repetitive transmission and/or reception of the device-to-device broadcast in one or more scheduling periods. The scheduling period here may be preset for example a value of 20 ms. A scheduling period first determining module determines one or more scheduling periods, and when performing repetitive transmission and/or reception of device-to-device broadcast in one or more scheduling periods, a schedule information third broadcasting module performs device-to-device schedule information broadcast based on the transmission pattern determined by the obtained row for device-to-device broadcast of schedule information according to the method described above in the one or more scheduling periods. Moreover, in another embodiment, when a scheduling period second determining module determines to perform repetitive transmission and/or reception of the device-to-device broadcast in a plurality of scheduling periods, a schedule information fourth broadcasting module performs device-to-device schedule information broadcast based on the transmission pattern determined for the obtained row for device-to-device broadcast of schedule information in respective scheduling periods according to the method described above; and the sequence number of the corresponding scheduling period is also broadcast simultaneously. In this way, when the user equipment obtains schedule information of other user equipment according to the method described above, it will simultaneously obtain the corresponding scheduling period sequence number, and uses the sequence number for merging the plurality of repetitive broadcasts. Additionally, in one preferred embodiment, when the user equipment performs repetitive transmission and/or reception of the device-to-device broadcast of schedule information in a plurality of scheduling periods, the user equipment may re-obtain a row in a Walsh matrix for device-to-device broadcast of schedule information according to the manner described above in different scheduling periods, thereby further avoiding the limitation of semi-duplexing.

In a preferred embodiment, the schedule information as described above may further include information of the transmission resource used by the user equipment for performing device-to-device broadcast communication, e.g., a resource block, etc. Based on the obtained transmission resource information, the user may select an appropriate transmission resource, e.g., an unused transmission resource, to perform device-to-device broadcast.

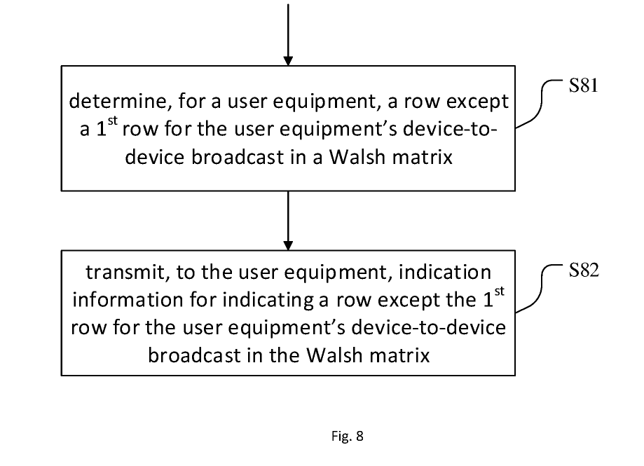

FIG. 8 shows a flow diagram of a method for facilitating device-to-device broadcast communication in a base station of a wireless communication network according to an embodiment of a further aspect of the present invention.

In step S81, the base station determines, for a user equipment, a row except the 1^{st} row for the user equipment's device-to-device broadcast in a Walsh matrix. Because the method for the base station to determine a row in a Walsh matrix for a user equipment has been described above, it will not be repeated here.

Next, in step S82, the base station transmits, to the user equipment, indication information for indicating a row except the 1^{st} row for the user equipment's device-to-device broadcast in the Walsh matrix. The base station may transmit the indication information to the user equipment based on any existing communication technology. Because those skilled in the art already know the technology of transmitting information, it will not be detailed here.

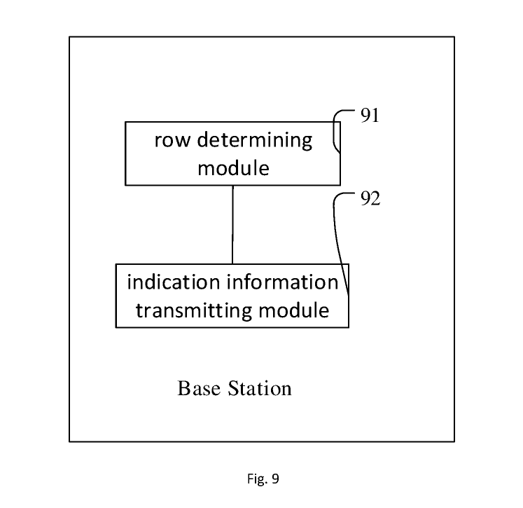

FIG. 9 shows a base station for facilitating device-to-device broadcast communication in a wireless communication network according to a still further aspect of the present invention.

A row determining module determines, for a user equipment, a row except the 1^{st} row for the user equipment's device-to-device broadcast in a Walsh matrix. Because the method for the base station to determine a row in a Walsh matrix for a user equipment has been described above, it will not be repeated here.

An indication information transmitting module transmits, to the user equipment, indication information for indicating a row except the 1^{st} row for the user equipment's device-to-device broadcast in the Walsh matrix. The base station may transmit the indication information to the user equipment based on any existing communication technology. Because those skilled in the art already know the technology of transmitting information, it will not be detailed here.

It should be noted that the present invention may be implemented in software and/or a combination of software and hardware. For example, each module of the present invention may be implemented by an application-specific integrated circuit (ASIC) or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft floppy or similar devices. Additionally, some steps or functions of the present invention may be implemented by hardware, for example, a circuit cooperating with the processor so as to implement various steps of functions.

Further, a portion of the present disclosure may be applied as a computer program product, for example, a computer program instruction, which, when executed by the computer, may invoke or provide a method and/or technical solution according to the present disclosure through operations of the computer. Further, the program instruction invoking the method of the present disclosure may be stored in a fixed or mobile recording medium, and/or transmitted through broadcast or data flow in other signal bearer media, and/or stored in a working memory of a computer device which operates based on the program instruction. Here, in an embodiment according to the present disclosure, an apparatus comprises a memory for storing a computer program instruction and a processor for executing the program instruction, wherein when the computer program instruction is executed by the processor, the apparatus is triggered to run the methods and/or technical solutions according to a plurality of embodiments of the present disclosure.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations fallen into the meaning and scope of equivalent elements of the claims is intended to be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for performing device-to-device broadcast communication at a user equipment of a wireless communication network, the method comprising:
obtaining a row except a 1^{st} row for device-to-device broadcast in a Walsh matrix;
performing device-to-device broadcast based on a transmission pattern determined by the obtained row, wherein the transmission pattern is: performing the following operations based on each element in the row sequentially:
when the element is a first value, performing broadcast transmission of a same data packet;
when the element is a second value, performing broadcast reception.

2. The method according to claim 1, wherein the obtaining a row except a 1^{st} row for device-to-device broadcast in a Walsh matrix comprises:
determining times required for repetitively broadcasting a data packet;
determining a Walsh matrix based on the repetitive times;
obtaining a row except the 1^{st} row for device-to-device broadcast in the Walsh matrix.

3. The method according to claim 1, wherein the obtaining a row except a 1^{st} row for device-to-device broadcast in a Walsh matrix comprises:
receiving indication information from a base station serving the user equipment, the indication information including an indication of a row except a 1^{st}row for device-to-device broadcast in a Walsh matrix;
obtaining a row except a 1^{st} row for device-to-device broadcast in a Walsh matrix based on the received indication information.

4. The method according to claim 1, wherein the obtaining a row except a 1^{st} row for device-to-device broadcast in a Walsh matrix comprises:
obtaining schedule information including a row for device-to-device broadcast in the Walsh matrix selected by other user equipment;
selecting a row except a 1^{st} row for device-to-device broadcast in the Walsh matrix based on the obtained schedule information.

5-9. (canceled)

10. A user equipment for performing device-to-device broadcast communication in a wireless communication network, the equipment comprising:
a row first obtaining module configured to obtain a row except a 1^{st} row for device-to-device broadcast in a Walsh matrix;
a broadcasting module configured to perform device-to-device broadcast based on a transmission pattern determined by the obtained row, wherein the transmission pattern is: performing the following operations based on each element in the row sequentially:
when the element is a first value, performing broadcast transmission of a same data packet;
when the element is a second value, performing broadcast reception.

11. The equipment according to claim 10, wherein the row first obtaining module comprises:
a repetitive times determining module configured to determine times required for repetitively broadcasting a data packet;
a matrix determining module configured to determine a Walsh matrix based on the repetitive times;
a row second obtaining module configured to obtain a row except the 1^{st} row for device-to-device broadcast in the Walsh matrix.

12. The equipment according to claim 10 or 11, wherein the row first obtaining module comprises:
an indication information receiving module configured to receive indication information from a base station serving the user equipment, the indication information including an indication of a row except a 1^{st} row for device-to-device broadcast in a Walsh matrix;
a row third obtaining module configured to obtain a row except a 1^{st} row for device-to-device broadcast in a Walsh matrix based on the received indication information.

13. The equipment according to claim 10, wherein the row first obtaining module comprises:
a schedule information first obtaining module configured to obtain schedule information including a row for device-to-device broadcast in the Walsh matrix selected by other user equipment;
a row fourth obtaining module configured to select a row except a 1^{st} row for device-to-device broadcast in the Walsh matrix based on the obtained schedule information.

14. The equipment according to claim 13, wherein the row first obtaining module further comprises:
a schedule information first broadcasting module configured to broadcast schedule information including the selected row;
a schedule information second obtaining module configured to obtain new schedule information including a row for device-to-device broadcast selected by other user equipment;
a determining module configured to determine whether the selected row can be used to perform device-to-device broadcast based on the obtained new schedule information;
a row re-obtaining module configured to, if the selected row cannot be used to perform device-to-device broadcast, then after a random time, re-obtain a row except a 1^{st} row for device-to-device broadcast in a Walsh matrix.

15. The equipment according to claim 13, wherein the equipment further comprises:
a row fifth obtaining module configured to obtain a row except a 1^{st} row for device-to-device broadcast of schedule information in a Walsh matrix;
a schedule information second broadcasting module configured to perform device-to-device broadcast of schedule information based on the obtained transmission pattern determined by the row for device-to-device broadcast of schedule information, wherein the transmission pattern is: performing the following operations for each element in the row sequentially:
when the element is a first value, performing broadcast transmission of same schedule information;
when the element is a second value, performing broadcast reception of schedule information.

16. The apparatus according to claim 15, wherein the schedule information second broadcasting module comprises:
a scheduling period first determining module configured to determine one or more scheduling period;
a schedule information third broadcasting module configured to perform device-to-device schedule information broadcast based on a transmission pattern determined by the obtained row for device-to-device broadcast of schedule information, wherein the transmission pattern is: performing the following operations based on each element in the row sequentially during the one or more scheduling periods:
when the element is a first value, performing broadcast transmission of same schedule information;
when the element is a second value, performing broadcast reception of schedule information.

17. The apparatus according to claim 16, wherein the schedule information third broadcasting module comprises:
a scheduling period second determining module configured to determine a plurality of scheduling periods;
a schedule information fourth broadcasting module configured to perform device-to-device broadcast of schedule information based on the obtained transmission pattern determined by the row for device-to-device broadcast of schedule information, wherein during each scheduling period, the following operations are performed for each element in the row sequentially:
when the element is a first value, performing broadcast transmission of same schedule information along with a scheduling period sequence number of the corresponding scheduling period;
when the element is a second value, performing broadcast reception of the schedule information.

18. The apparatus according to claim 14, wherein the schedule information comprises:
information of a transmission resource used for performing device-to-device broadcast communication.

19. A method for facilitating device-to-device broadcast communication at a base station of a wireless communication network, the method comprises:
determining, for a user equipment, a row except a 1^{st} row for the user equipment's device-to-device broadcast in a Walsh matrix;
transmitting, to the user equipment, indication information for indicating a row except the 1^{st} row for the user equipment's device-to-device broadcast in the Walsh matrix.

20. A base station facilitating device-to-device broadcast communication at a base station of a wireless communication network, the base station comprising:
a row determining module configured to determine, for a user equipment, a row except a 1^{st} row for the user equipment's device-to-device broadcast in a Walsh matrix;
an indication information transmitting module configured to transmit, to the user equipment, indication information for indicating a row except the 1^{st} row for the user equipment's device-to-device broadcast in the Walsh matrix.
